(19) United States
(12) Patent Application Publication
(10) Pub. No.: US 2025/0274464 A1
(43) Pub. Date: Aug. 28, 2025

(54) CYBERTHREAT PENETRATION DETECTION USING AN ANOMALY DETECTION MODEL

(71) Applicant: Bank of America Corporation, Charlotte, NC (US)

(72) Inventors: Edward L. Traywick, Belbrook, OH (US); Nicholas O'Reilly, Dallas, TX (US); Laura Stillman Lavender, Washington, DC (US)

(21) Appl. No.: 18/587,224

(22) Filed: Feb. 26, 2024

(51) Int. Cl. H04L 9/40

(52) U.S. Cl. CPC H04L 63/1425; H04L 63/1441

(57) ABSTRACT

Aspects related to cyberthreat penetration detection using an anomaly detection model are provided. A cyberthreat detection platform may generate user profiles. The platform may train an anomaly detection model based on the user profiles. The platform may identify, using the anomaly detection model, an anomalous connection to a network. The platform may partition a user device associated with the anomalous connection. The platform may generate, based on inputting user information of the anomalous connection into the anomaly detection model, a cyberthreat score. The platform may identify whether the cyberthreat score satisfies a threshold score. The platform may initiate, based on identifying that the cyberthreat score satisfies the threshold score, cyberthreat remediation actions. The platform may update the anomaly detection model based on initiating the cyberthreat remediation actions.

### BACKGROUND

Aspects described herein are related to cyberthreat penetration detection using an anomaly detection model. In some instances, entities such as an enterprise organization (e.g., a financial institution, and/or other institutions) may maintain a network of associated devices (e.g., user devices, such as laptops, cell phones, and the like, corresponding to employees and/or customers of the enterprise organization). In some instances, users (e.g., employees and/or customers of the enterprise organization) may connect to the network via user devices in order to access resources of the enterprise organization (e.g., applications, user accounts, and the like). In some examples, one or more systems connected to the network may be used to authenticate the connections of user devices, for example, based on user profiles associated with the user devices. However, in some examples, cyberthreat actors may spoof, imitate, and/or otherwise impersonate a user associated with a user profile to connect to the network. After connecting to the network, the cyberthreat actors may deploy one or more cyberthreats (e.g., viruses, ransomware, malware, unauthorized access points, security risks, and/or other cyberthreats). Accordingly, it may be important to detect cyberthreat actors impersonating a valid user profile before the cyberthreat actors can perform any cyberthreat actions. Additionally, in some examples, the cyberthreat actors may impersonate the user via a first connection while the user is accessing the network via a second connection. Accordingly, it may also be important to provide methods of detecting and remediating cyberthreats accurately and efficiently without disrupting valid/legitimate user connections.

### SUMMARY

Aspects of the disclosure provide effective, efficient, scalable, and convenient technical solutions that address and overcome the technical problems associated with current methods of performing cyberthreat penetration detection. In accordance with one or more arrangements of the disclosure, a computing platform with at least one processor, a communication interface, and memory storing computer-readable instructions may generate a plurality of user profiles based on registration information of users. A given user profile may comprise user information for a corresponding user. The computing platform may identify one or more user devices requesting a connection to a network based on monitoring the network. The computing platform may train an anomaly detection model based on the plurality of user profiles. Training the anomaly detection model may configure the anomaly detection model to identify anomalous connections and generate cyberthreat scores for connections based on input of user information. The computing platform may identify an anomalous connection associated with a user device, of the one or more user devices, based on inputting user information associated with the user device into the anomaly detection model and based on a preliminary comparison of the user information to a user profile of the plurality of user profiles. The computing platform may initiate one or more partitioning actions for the user device based on identifying the anomalous connection. The computing platform may generate a cyberthreat score for the anomalous connection based on the user information and using the anomaly detection model. The computing platform may identify whether the cyberthreat score satisfies the threshold score by comparing the cyberthreat score to a threshold score. The threshold score may indicate the anomalous connection is a cyberthreat if the cyberthreat score satisfies the threshold score. The computing platform may initiate one or more cyberthreat remediation actions for the anomalous connection based on identifying that the cyberthreat score satisfies the threshold score. The computing platform may update the anomaly detection model based on initiating the one or more cyberthreat remediation actions.

In one or more examples, the computing platform may generate the cyberthreat score with the anomaly detection model by comparing the user information, identifying, based on the comparing, one or more shared characteristics between the user information and the user profile corresponding to the user, and generating, based on the identifying the one or more shared characteristics, a cyberthreat score representing a likelihood of the anomalous connection being initiated by a cyberthreat actor. In one or more arrangements, the computing platform may generate the cyberthreat score based on identifying the one or more shared characteristics by generating, based on the one or more shared characteristics, an initial cyberthreat score, applying one or more weighting values to the one or more shared characteristics, and updating the initial cyberthreat score based on the one or more weighting values.

In one or more examples, the computing platform may update the user profile corresponding to the user based on identifying whether the cyberthreat score satisfies the threshold score and based on user information associated with the anomalous connection. In one or more arrangements, the one or more cyberthreat remediation actions may comprise one or more of: causing a password reset, disrupting the anomalous connection, adding the user device to a watchlist of known cyberthreats, implementing additional authentication requirements for a user profile, of the plurality of user profiles, associated with the user device, and/or causing output of a cyberthreat review notification.

In one or more examples, the one or more cyberthreat remediation actions may comprise incrementing a cyberthreat counter associated with the user device, identifying whether the cyberthreat counter meets or exceeds the threshold counter based on incrementing the cyberthreat counter and by comparing the cyberthreat counter to a threshold counter, and outputting an indication that the user device is associated with a cyberthreat actor based on identifying that the cyberthreat counter meets or exceeds the threshold counter. In one or more arrangements, the computing platform may compare the cyberthreat score to a second threshold score. The second threshold score may exceed the threshold score. The computing platform may identify, based on the comparing, whether the cyberthreat score meets or exceeds the second threshold score. The computing platform may, based on identifying that the cyberthreat score meets or exceeds the second threshold score, increase a frequency of authentication requests based on a user profile, of the plurality of user profiles, associated with the user device. In one or more examples, initiating the one or more cyberthreat remediation actions may comprise initiating, for the user device associated with the anomalous connection, the one or more cyberthreat remediation actions, and maintaining, uninterrupted, a connection for a second device, associated with a verified connection and with a user profile corresponding to the anomalous connection.

These features, along with many others, are discussed in greater detail below.

### BRIEF DESCRIPTION OF THE DRAWINGS

The present disclosure is illustrated by way of example and not limited in the accompanying figures in which like reference numerals indicate similar elements and in which:

FIGS. 1A-1B depict an illustrative computing environment for cyberthreat penetration detection using an anomaly detection model in accordance with one or more example arrangements;

FIGS. 2A-2E depict an illustrative event sequence for cyberthreat penetration detection using an anomaly detection model in accordance with one or more example arrangements;

FIG. 3 depicts an illustrative graphical user interface depicting a cyberthreat review interface generated as part of cyberthreat penetration detection using an anomaly detection model in accordance with one or more example arrangements; and

FIG. 4 depicts an illustrative method for cyberthreat penetration detection using an anomaly detection model in accordance with one or more example arrangements.

### DETAILED DESCRIPTION

In the following description of various illustrative arrangements, reference is made to the accompanying drawings, which form a part hereof, and in which is shown, by way of illustration, various arrangements in which aspects of the disclosure may be practiced. In some instances, other arrangements may be utilized, and structural and functional modifications may be made, without departing from the scope of the present disclosure.

It is noted that various connections between elements are discussed in the following description. It is noted that these connections are general and, unless specified otherwise, may be direct or indirect, wired or wireless, and that the specification is not intended to be limiting in this respect.

As a brief description of the concepts described further herein, some aspects of the disclosure relate to cyberthreat penetration detection using an anomaly detection model. In some instances, entities such as an enterprise organization (e.g., a financial institution, and/or other institutions) may maintain a network of associated devices (e.g., user devices, such as laptops, cell phones, and the like, corresponding to employees and/or customers of the enterprise organization). In some instances, cyberthreat actors may attempt to gain unauthorized access to the network by impersonating an authorized user (e.g., by accessing the network via credentials, profiles, and/or other indicators of an authorized user's identity). For example, cyberthreat actors may steal, spoof, and/or otherwise make illegitimate use of an authorized user's identity and/or user profile to gain access to the network. In some instances, once a cyberthreat actor accesses the network, the cyberthreat actor may deploy, initiate, and/or otherwise cause one or more cyberthreat actions (e.g., viruses, ransomware, malware, unauthorized access points, security risks, and/or other cyberthreats). Additionally, in some examples, the cyberthreat actors may impersonate a legitimate user while the legitimate user is accessing, or attempting to access, the network. Conventional methods of detecting cyberthreat penetration may be insufficient to identify cyberthreat actors making illegitimate connections before the cyberthreat actors cause the one or more cyberthreat actions. Additionally, conventional methods of remediating detected cyberthreats (e.g., blocking a user profile, adding user credentials to a watchlist, disconnecting a device, and/or other methods) may affect legitimate and illegitimate connections indiscriminately. Thus, there exists a need for providing a means by which cyberthreat penetration may be detected and remediated before cyberthreat actors cause cyberthreat actions, and without negatively impacting legitimate connections to the network.

Accordingly, in some instances, entities such as an enterprise organization and/or other organizations/institutions may employ a cyberthreat detection platform, as described herein. A cyberthreat detection platform may generate profiles for users registered with the enterprise organization. For example, the cyberthreat detection platform may generate a profile for each user (e.g., employees and/or customers of the enterprise organization) with user information (e.g., geographical location, IP address, time zone, working hours, authentication questions, and/or other user information), indicators of devices associated with the user (e.g., mobile phones, laptops, computers, tablets and/or other devices associated with employees and/or customers of the enterprise organization), and/or other information. The cyberthreat detection platform may use the user profiles to identify anomalous connections to the network as potential cyberthreats. The cyberthreat detection platform may generate, based on user information, cyberthreat scores for anomalous connections. The cyberthreat score may be compared to thresholds to identify whether the anomalous connection is associated with a cyberthreat and/or a cyberthreat actor. During and/or as part of the cyberthreat penetration detection processes described herein, the cyberthreat detection platform may partition anomalous connections from full access to the network (e.g., by placing the device associated with the anomalous connection in a sandbox environment, displaying modified resources lacking sensitive information, screening packets of information sent to and/or from the device, and/or otherwise partitioning the device). Based on identifying that the anomalous connection is associated with a cyberthreat, the cyberthreat detection platform may initiate cyberthreat remediation actions (e.g., severing a connection to a network, requiring additional authentication information, adding the device associated with the anomalous connection to a watchlist, displaying an alert interface, and/or other remediation actions). The cyberthreat remediation platform may be configured to perform the cyberthreat penetration detection processes described herein without affecting a non-anomalous connection linked to the same user profile as an anomalous connection.

In some examples, in performing the methods of deploying and/or utilizing the cyberthreat detection platform as described herein, the cyberthreat detection platform may train one or more machine learning models. For example, the cyberthreat detection platform may train an anomaly detection model based on the user profiles. Training the anomaly detection model may configure the anomaly detection model to generate cyberthreat scores for anomalous connections, based on the user profiles.

These and various other aspects will be discussed more fully herein.

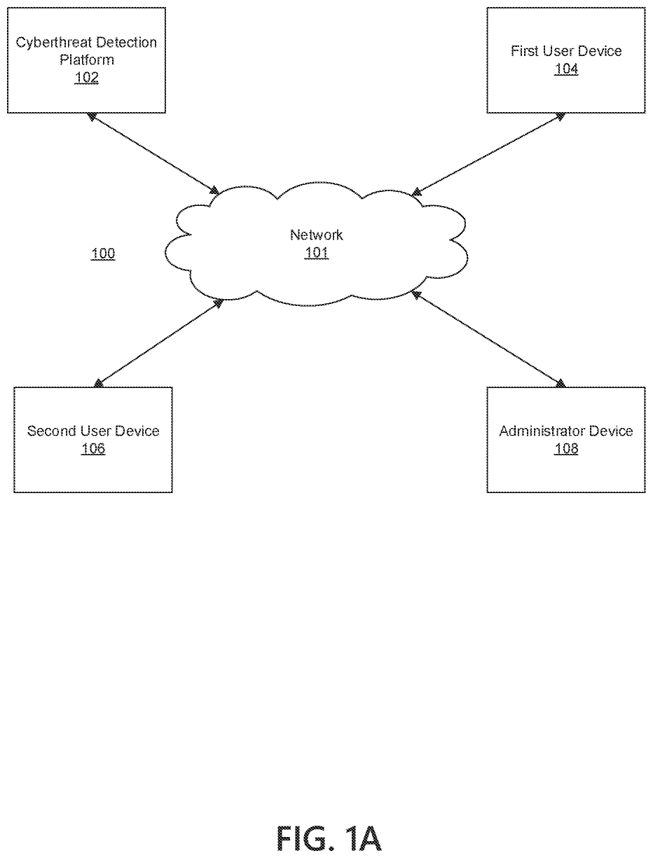

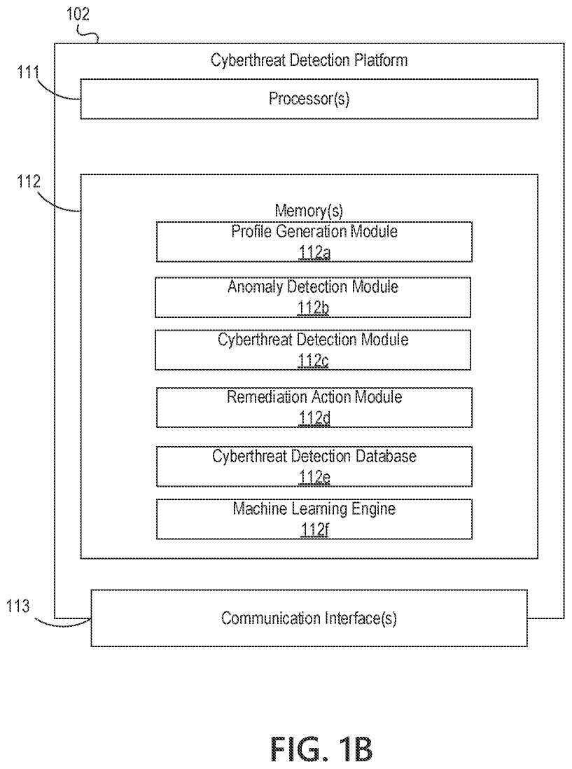

FIGS. 1A-1B depict an illustrative computing environment for cyberthreat penetration detection using an anomaly detection model in accordance with one or more example arrangements. Referring to FIG. 1A, computing environment 100 may include one or more computer systems. For example, computing environment 100 may include a cyberthreat detection platform 102, a first user device 104, a second user device 106, and an administrator device 108.

As described further below, cyberthreat detection platform 102 may be a computer system that includes one or more computing devices (e.g., servers, laptop computer, desktop computer, mobile device, tablet, smartphone, and/or other devices) and/or other computer components (e.g., processors, memories, communication interfaces) that may be used to configure, train, and/or execute one or more machine learning models (e.g., an anomaly detection model, and/or other models). For example, the cyberthreat detection platform 102 may train an anomaly detection model to generate cyberthreat scores for one or more anomalous connections. The cyberthreat scores may be used to detect cyberthreat penetration based on the anomalous connections. The cyberthreat detection platform 102 may be managed by and/or otherwise associated with an enterprise organization (e.g., a financial institution, and/or other institutions) that may, e.g., be associated with one or more additional systems (e.g., first user device 104, second user device 106, administrator device 108, and/or other systems). In one or more instances, the cyberthreat detection platform 102 may be configured to communicate with one or more systems (e.g., first user device 104, second user device 106, administrator device 108, and/or other systems) to perform an information transfer, identify an anomalous connection, display a user interface, partition a device, and/or perform other functions.

The first user device 104 may be a computing device (e.g., laptop computer, desktop computer, mobile device, tablet, smartphone, server, server blade, and/or other device) and/or other data storing or computing component (e.g., processors, memories, communication interfaces, databases) that may be used to transfer information between devices and/or perform other user functions (e.g., provide authentication information, connect to a network, access resources of the network, and/or other functions). The first user device 104 may possess and/or be associated with one or more identifying characteristics (e.g., an IP address, a geographical location, a MAC address, and/or other identifying characteristics). In some examples, the first user device 104 may be associated with a particular user (e.g., an employee and/or a customer of the enterprise organization) through a user identifier (e.g., a username, an employee number, a customer number, and/or other user identifiers) stored by the first user device 104. In some instances, the first user device 104 may be configured to communicate with one or more systems (e.g., cyberthreat detection platform 102, and/or other systems) as part of transmitting a message, initiating a cyberthreat remediation action, and/or to perform other functions.

The second user device 106 may be a computing device (e.g., laptop computer, desktop computer, mobile device, tablet, smartphone, server, server blade, and/or other device) and/or other data storing or computing component (e.g., processors, memories, communication interfaces, databases) that may be used to transfer information between devices and/or perform other user functions (e.g., provide authentication information, connect to a network, access resources of the network, and/or other functions). For example, the second user device 106 may be a computing device similar to the first user device 104. The second user device 106 may possess and/or be associated with one or more identifying characteristics (e.g., an IP address, a geographical location, a MAC address, and/or other identifying characteristics). In some examples, the second user device 106 may be associated with a particular user (e.g., an employee and/or a customer of the enterprise organization) through a user identifier (e.g., a username, an employee number, a customer number, and/or other user identifiers) stored by the second user device 106. In some instances, the second user device 106 may be configured to communicate with one or more systems (e.g., cyberthreat detection platform 102, and/or other systems) as part of transmitting a message, initiating a cyberthreat remediation action, and/or to perform other functions.

The administrator device 108 may be a computing device (e.g., laptop computer, desktop computer, mobile device, tablet, smartphone, server, server blade, and/or other device) and/or other data storing or computing component (e.g., processors, memories, communication interfaces, databases) that may be used to transfer information between devices and/or perform other user functions (e.g., displaying an interface, and/or other functions). For example, the administrator device 108 may be a computing device similar to first user device 104 and/or second user device 106. In one or more instances, administrator device 108 may correspond to an entity (e.g., an enterprise organization, such as a financial institution and/or other institution). For example, the administrator device 108 may correspond to the same entity associated with the cyberthreat detection platform 102. In one or more examples, the administrator device 108 may be associated with an administrator account/profile of the enterprise organization and may, for example, be configured to cause the cyberthreat detection platform 102 to initiate cyberthreat remediation actions based on detecting cyberthreat penetration. In one or more instances, the administrator device 108 may be configured to communicate with one or more systems (e.g., cyberthreat detection platform 102, and/or other systems) to receive transmissions from other user devices, provide user feedback, and/or to perform other functions. In some instances, the administrator device 108 may be configured to display one or more graphical user interfaces (e.g., cyberthreat review interfaces, and/or other interfaces).

Although three user/administrator devices are depicted herein, any number of such devices may be used to implement the methods and arrangements described herein without departing from the scope of the disclosure.

Computing environment 100 also may include one or more networks, which may interconnect cyberthreat detection platform 102, first user device 104, second user device 106, and administrator device 108. For example, computing environment 100 may include a network 101 (which may interconnect, e.g., cyberthreat detection platform 102, first user device 104, second user device 106, and administrator device 108).

In one or more arrangements, cyberthreat detection platform 102, first user device 104, second user device 106, and administrator device 108 may be any type of computing device capable of sending and/or receiving requests and processing the requests accordingly. For example, cyberthreat detection platform 102, first user device 104, second user device 106, and administrator device 108, and/or the other systems included in computing environment 100 may, in some instances, be and/or include server computers, desktop computers, laptop computers, tablet computers, or the like that may include one or more processors, memories, communication interfaces, storage devices, and/or other components. As noted above, and as illustrated in greater detail below, any and/or all of cyberthreat detection platform 102, first user device 104, second user device 106, and administrator device 108, may, in some instances, be special-purpose computing devices configured to perform specific functions.

Referring to FIG. 1B, cyberthreat detection platform 102 may include one or more processors 111, memory 112, and communication interface 113. A data bus may interconnect processors 111, memory 112, and communication interface 113. Communication interface 113 may be a network interface configured to support communication between cyberthreat detection platform 102 and one or more networks (e.g., network 101, or the like). Communication interface 113 may be communicatively coupled to the processors 111. Memory 112 may include one or more program modules having instructions that, when executed by processors 111, cause cyberthreat detection platform 102 to perform one or more functions described herein, and/or one or more databases (e.g., a cyberthreat detection database 112e, or the like) that may store and/or otherwise maintain information which may be used by such program modules and/or processor 111. In some instances, the one or more program modules and/or databases may be stored by and/or maintained in different memory units of cyberthreat detection platform 102 and/or by different computing devices that may form and/or otherwise make up cyberthreat detection platform 102. For example, memory 112 may have, host, store, and/or include a profile generation module 112a, an anomaly detection module 112b, a cyberthreat detection module 112c, a remediation action module 112d, a cyberthreat detection database 112e, a machine learning engine 112f, and/or other modules and/or databases.

Profile generation module 112a may have instructions that direct and/or cause cyberthreat detection platform 102 to communicate with the network 101, receive user information, generate user profiles, and/or perform other functions. Anomaly detection module 112b may have instructions that direct and/or cause cyberthreat detection platform 102 to monitor the network 101 for connections from user devices (e.g., first user device 104, second user device 106, and/or other devices), intercept transmitted messages, packets, and/or other information, compare intercepted information to user profiles and/or portions of user profiles to identify anomalous connections, and/or perform other functions. Cyberthreat detection module 112c may have instructions that direct and/or cause cyberthreat detection platform 102 to generate cyberthreat scores for anomalous connections, partition user devices from the network 101, update user information for user profiles, and/or perform other functions. Remediation action module 112d may have instructions that direct and/or cause cyberthreat detection platform 102 to initiate one or more remediation actions configured to prevent unauthorized access to the network 101 and/or to respond to cyberthreat penetration detection. Cyberthreat detection database 112e may have instructions causing cyberthreat detection platform 102 to store user profiles, parameters for remediation actions, and/or other information. Machine learning engine 112f may have instructions to train, implement, and/or update one or more machine learning models, such as an anomaly detection model, and/or other machine learning models.

Although profile generation module 112a, anomaly detection module 112b, cyberthreat detection module 112c, remediation action module 112d, cyberthreat detection database 112e, and machine learning engine 112f are depicted as separate modules herein, the instructions stored by these modules may be stored in any number of modules without departing from the scope of this disclosure.

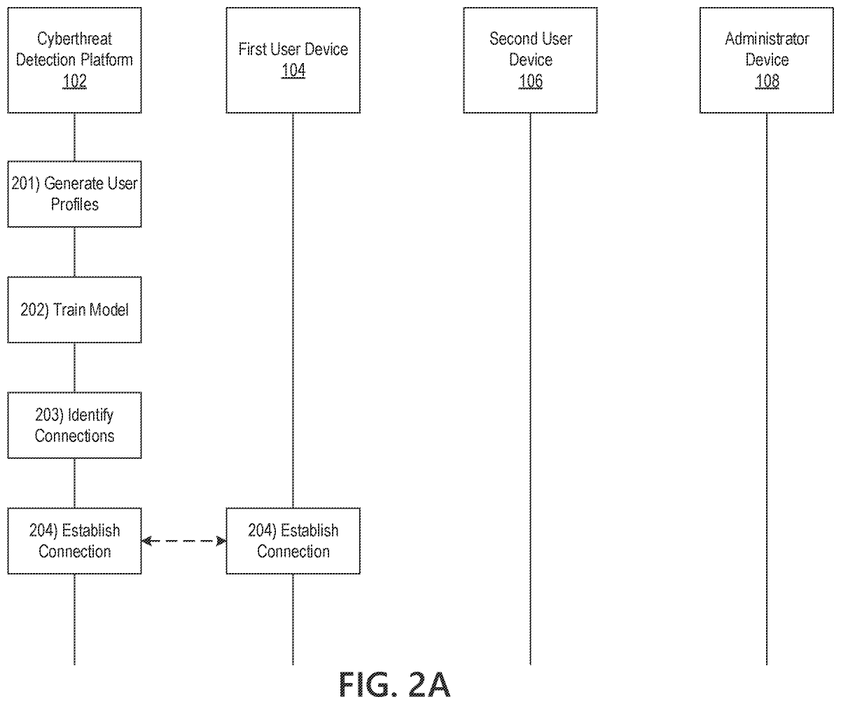

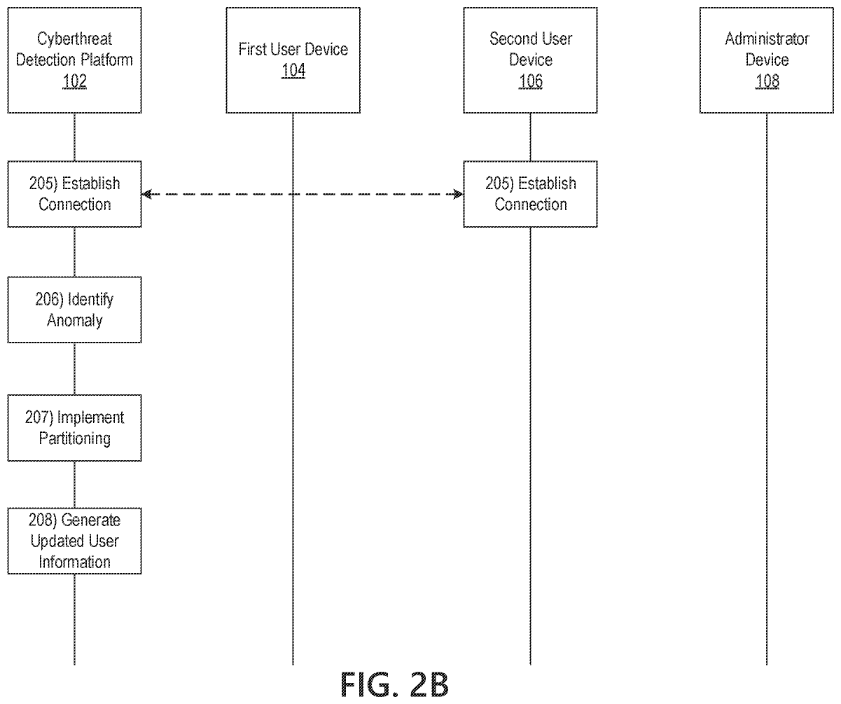

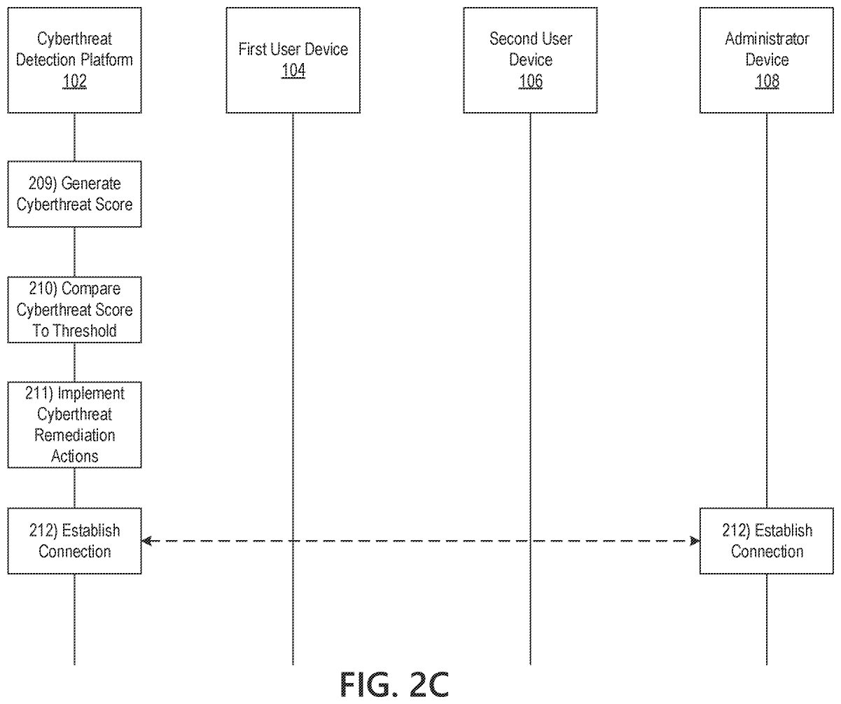

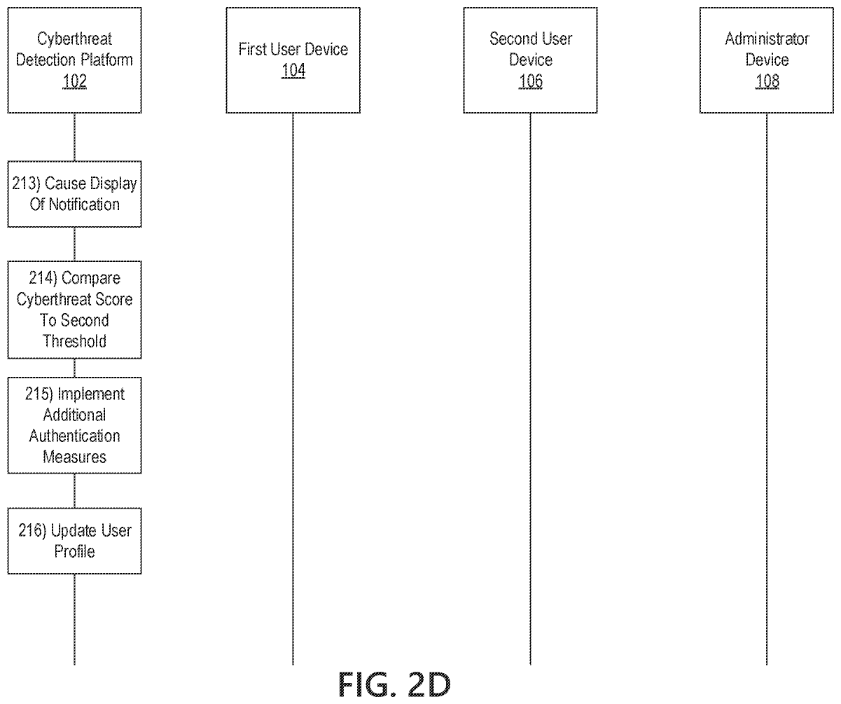

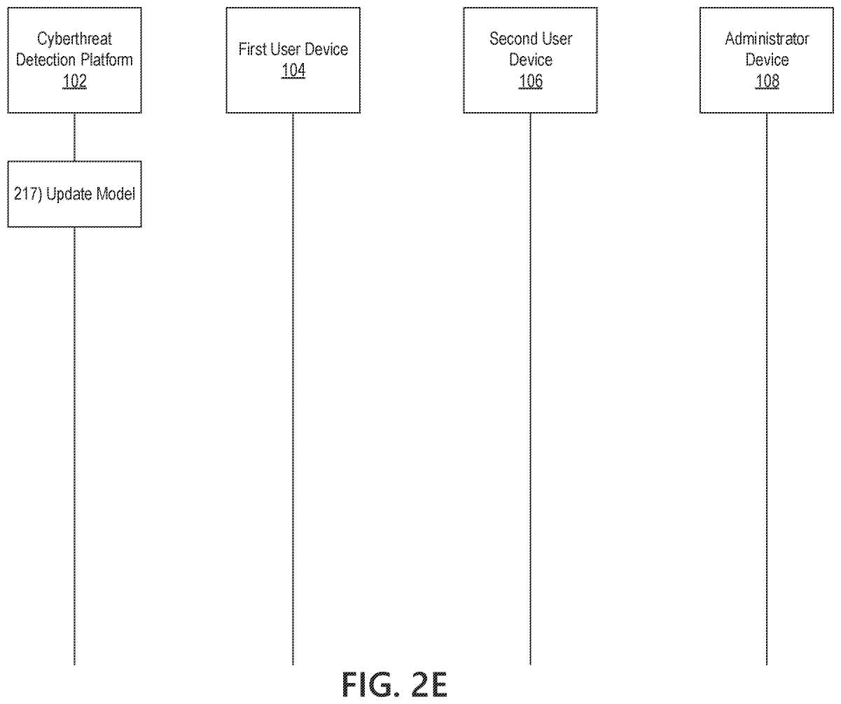

FIGS. 2A-2E depict an illustrative event sequence for cyberthreat penetration detection using an anomaly detection model in accordance with one or more example arrangements. Referring to FIG. 2A, at step 201, the cyberthreat detection platform 102 may generate user profiles. For example, the cyberthreat detection platform 102 may generate a user profile for each user (e.g., a customer of an enterprise organization, such as a financial institution and/or other institutions, an employee of the enterprise organization, and/or other users). The user profiles may be and/or comprise user information associated with the user. For example, the user profiles may be and/or comprise information such as demographic information (e.g., names, usernames, account numbers, customer numbers, employee numbers, a location of the user (e.g., a home or work address), a status of the user (e.g., customer, remote employee, in-office employee, and/or other demographic information), device information (e.g., device identifiers such as an IP address, a MAC address, a device serial number, and/or other identifiers, geographic location associated with a device linked to the user, a version number of a program associated with connecting a device to a network such as network 101, an operating system associated with a device, and/or other device information), behavioral information and/or access patterns (e.g., an employee's working hours, indications of the usual times and/or days that a user accesses a network such as network 101, an indication of a web browser commonly used by the user, an indication of the first application typically opened by the user when connecting to a network such as network 101, and/or other behavioral information) and/or other information. In some instances, in generating the user profiles, the cyberthreat detection platform 102 may generate the user profiles based on registration information associated with individual users. For example, one or more users may register with the cyberthreat detection platform 102 and/or services, applications, or the like associated with the enterprise organization managing the cyberthreat detection platform 102 by providing user information used to generate the user profiles. In some examples, in generating the user profiles, the cyberthreat detection platform 102 may generate the user profiles by storing the user information in memory (e.g., memory 112, and/or other memory). The user profiles may be and/or comprise information captured, for each user, during the general use of user devices connected to the network 101 and/or other networks associated with the enterprise organization associated with the cyberthreat detection platform 102 and with the permission of each user.

At step 202, the cyberthreat detection platform 102 may train a machine learning model. For example, the cyberthreat detection platform 102 may train an anomaly detection model configured to identify anomalous connections between devices and a network, such as network 101, and to generate cyberthreat scores for connections based on input of user information. In some instances, the cyberthreat detection platform 102 may configure and/or otherwise train the anomaly detection model based on user profiles associated with one or more devices. For example, the cyberthreat detection platform 102 may configure and/or otherwise train the anomaly detection model based on the user profiles generated at step 201. In some instances, to configure and/or otherwise train the anomaly detection model, the cyberthreat detection platform 102 may process the user profiles by applying natural language processing, natural language understanding, supervised machine learning techniques (e.g., regression, classification, neural networks, support vector machines, random forest models, naïve Bayesian models, and/or other supervised techniques), unsupervised machine learning techniques (e.g., principal component analysis, hierarchical clustering, K-means clustering, and/or other unsupervised techniques), and/or other techniques.

In some examples, in configuring and/or otherwise training the anomaly detection engine, the cyberthreat detection platform 102 may cause the anomaly detection engine to store one or more correlations between devices and user profiles for use in detecting anomalies and/or generating cyberthreat scores for connections between the devices and a network, such as network 101. For example, based on user information, from a user profile, indicating that a device (e.g., first user device 104, or the like) corresponding to a specific MAC address is associated with a particular user profile, the cyberthreat detection platform 102 may cause the anomaly detection model to store a correlation between the device corresponding to the specific MAC address and the particular user profile such that connections from devices corresponding to a different MAC address and connecting to the network 101 via the same user profile will be identified as anomalous connections. In configuring and/or otherwise training the anomaly detection model the cyberthreat detection platform 102 may store one or more correlations for each device associated with each user profile of the one or more user profiles generated at step 201. Accordingly, the cyberthreat detection platform 102 may configure and/or otherwise train the anomaly detection model to identify anomalous connections based on identifying that connections from devices accessing a network, such as network 101, via a user profile (e.g., by presenting credentials indicating the device is being used by the user associated with the user profile) are anomalous connections if the devices do not match the stored correlations.

Additionally or alternatively, in some examples, the cyberthreat detection platform 102 may configure and/or otherwise train the anomaly detection model to generate the cyberthreat scores by comparing user information associated with a connection to a user profile associated with the connection. For example, the cyberthreat detection platform 102 may configure and/or train the anomaly detection model to use the stored correlations to identify shared characteristics between the user information associated with a connection and the user profile associated with the user identified as initiating the connection. For example, the cyberthreat detection platform 102 may configure and/or train the anomaly detection model to generate different cyberthreat scores for connections with, for example, one shared characteristic than for connections with, for example, three shared characteristics. For instance, the anomaly detection model may generate a cyberthreat score for a connection that, based on the stored correlations, corresponds to the username of a user profile associated with the device initiating the connection but shares no other characteristics with the user profile. The cyberthreat score for the connection may exceed a cyberthreat score for a second connection that, based on the stored correlations, corresponds to the username, access patterns (e.g., the web browser used by the device initiating the connection), and device identifier (e.g., MAC address) of the user profile associated with the device initiating the connection. It should be noted that the above are merely a few example methods by which the cyberthreat detection platform 102 may train the anomaly detection model and that the cyberthreat detection platform 102 may additionally and/or alternatively configure and/or otherwise train the anomaly detection model based on additional parameters and/or training information without departing from the scope of this disclosure.

At step 203, the cyberthreat detection platform 102 may identify one or more connections to the network 101. For example, based on monitoring network traffic (e.g., sent/received packets, access requests, or the like) of the network 101 the cyberthreat detection platform 102 may identify requests from one or more devices to access the network 101. In some examples, the requests from the one or more devices may be associated with particular users. For example, a device (e.g., first user device 104, second user device 106, or the like) may send a request to connect to the network 101 with identifying information (e.g., a username, password, and/or other credentials) associated with a user (e.g., an employee and/or a customer of the enterprise organization associated with the cyberthreat detection platform 102). The user and/or the device may be associated with a user profile generated and/or stored by the cyberthreat detection platform 102. In some examples, the cyberthreat detection platform 102 may identify two or more connections corresponding to the same user profile. For example, a first device (e.g., first user device 104, or the like) may send a request to connect to the network 101 with identifying information (e.g., a username, password, and/or other credentials) associated with a user (e.g., an employee and/or a customer of the enterprise organization associated with the cyberthreat detection platform 102) corresponding to a user profile and a second device (e.g., second user device 106, or the like) may also send a request, prior to or during the connection of the first device, to connect to the network 101 with identifying information (e.g., a username, password, and/or other credentials) associated with the user (e.g., the employee and/or the customer of the enterprise organization associated with the cyberthreat detection platform 102) corresponding to the same user profile. In these examples, the cyberthreat detection platform 102 may identify both connections by monitoring the network 101.

At step 204, based on identifying the one or more connections at step 203, the cyberthreat detection platform 102 may establish a connection with the first user device 104. For example, the cyberthreat detection platform 102 may establish a first wireless data connection with the first user device 104 to link the first user device 104 with the cyberthreat detection platform 102 (e.g., in preparation for identifying anomalous connections, and/or other functions). In some instances, the cyberthreat detection platform 102 may identify whether or not a connection is already established with the first user device 104. If a connection is already established with the first user device 104, the cyberthreat detection platform 102 might not re-establish the connection. If a connection is not yet established with the first user device 104, the cyberthreat detection platform 102 may establish the first wireless data connection as described above.

It should be understood that while a single connection is described with respect to step 204 the cyberthreat detection platform 102 may establish connections with any and/or all of the other devices associated with connections identified at step 203 (e.g., as part of performing cyberthreat penetration methods described herein for each of the other devices). Additionally or alternatively, in some examples, based on identifying, at step 203, a second connection between a second device (e.g., second user device 106, or the like) and the network 101 associated with the user corresponding to first user device 104, the cyberthreat detection platform 102 may establish, simultaneously, near-simultaneously, and/or while maintaining the first wireless data connection, a second wireless data connection (e.g., as described below at step 205). If the cyberthreat detection platform 102 does not identify the second connection between the second device (e.g., second user device 106, or the like) and the network 101 associated with the user corresponding to first user device 104 the cyberthreat detection platform 102 might not establish the second wireless data connection and may proceed to step 206 without performing the functions of step 205.

Referring to FIG. 2B, at step 205, the cyberthreat detection platform 102 may establish a connection with the second user device 106. For example, the cyberthreat detection platform 102 may establish the connection with the second user device 106 based on identifying that a connection between the second user device 106 and the network 101 is associated with the same user and/or user profile as the connection between the first user device 104 and the network 101. In establishing the connection with the second user device 106, the cyberthreat detection platform 102 may establish a second wireless data connection with the second user device 106 to link the second user device 106 with the cyberthreat detection platform 102 (e.g., in preparation for identifying anomalous connections, and/or other functions). In some instances, the cyberthreat detection platform 102 may identify whether or not a connection is already established with the second user device 106. If a connection is already established with the second user device 106, the cyberthreat detection platform 102 might not re-establish the connection. If a connection is not yet established with the second user device 106, the cyberthreat detection platform 102 may establish the second wireless data connection as described above.

At step 206, the cyberthreat detection platform 102 may identify an anomalous connection of the one or more connections identified at step 203. The anomalous connection may be a connection initiated by and/or otherwise associated with a user device (e.g., first user device 104, second user device 106, or the like). For example, the cyberthreat detection platform 102 may identify an anomalous connection based on inputting user information associated with one or more user devices (e.g., first user device 104, second user device 106, and/or other user devices) and/or connections identified at step 203 into the anomaly detection model. For instance, based on identifying a connection between the first user device 104 (and/or the second user device 106) and the network 101, the cyberthreat detection platform 102 may input user information included in the request from the first user device 104 (and/or the second user device 106) to connect to the cyberthreat detection platform 102. The user information may be identified by the cyberthreat detection platform 102 during the connection between the first user device 104 (and/or the second user device 106), and/or may be otherwise associated with the first user device 104 (and/or the second user device 106). The user information may be and/or comprise information such as demographic information (e.g., names, usernames, account numbers, customer numbers, employee numbers, a location of the user (e.g., a home or work address), a status of the user (e.g., customer, remote employee, in-office employee, and/or other demographic information), device information for the first user device 104 and/or second user device 106 (e.g., device identifiers such as an IP address, a MAC address, a device serial number, and/or other identifiers, the geographic location from which the first user device 104 and/or second user device 106 is connecting to the network 101, a version number of a program associated with connecting the first user device 104 and/or second user device 106 to network 101, an operating system associated with the first user device 104 and/or second user device 106, and/or other device information), information associated with the connection between the first user device 104 and/or second user device 106 and the network 101 (e.g., an indication of the time of day the request was made, an indication of a web browser associated with the connection, an indication of the first application opened during the connection with the 101, and/or other information associated with the connection(s)) and/or other information.

In identifying the anomalous connection, based on inputting the user information, the cyberthreat detection platform 102 may cause the anomaly detection model to identify whether a connection is anomalous based on stored correlations. For example, based on inputting the user information of the first user device 104 (and/or the second user device 106) into the anomaly detection model, the cyberthreat detection platform 102 may cause the anomaly detection model to compare the user information to a user profile associated with the user of the first user device 104 (and/or second user device 106) after identifying the user profile based on correlations stored by the anomaly detection model. In comparing the user information to the user profile, the cyberthreat detection platform 102 may cause the anomaly detection model to identify, based on the stored correlations, an anomaly between the user information and the user profile. For example, based on a stored correlation indicating that the user associated with the user profile is a remote employee of the enterprise organization working from location A, and based on the anomaly detection model identifying that the first user device 104 is accessing network 101 from location B, the anomaly detection model may identify an anomaly (i.e., that the first user device 104 is accessing the network allegedly under direction of the user, but not from a location associated with the user). In some examples, the cyberthreat detection platform 102 may cause the anomaly detection model to identify anomalies based on comparing only a portion of the user information to the user profile. For example, based on one or more parameters (which may, e.g., be determined by a user of the cyberthreat detection platform 102, by a ruleset stored in memory 112 of the cyberthreat detection platform 102, and/or by other sources), the cyberthreat detection platform 102 may cause the anomaly detection model to identify anomalies based on a portion of the user information (e.g., device identifiers, geographic location, or the like) rather than the entirety of the user information. Accordingly, the cyberthreat detection platform 102 may cause the anomaly detection model to identify anomalies by performing a preliminary analysis of the user information of first user device 104 and/or second user device 106, but without analyzing the entirety of the user information of the first user device 104 and/or second user device 106.

Additionally or alternatively, in some examples, based on identifying two or more connections from different devices (e.g., from both the first user device 104 and the second user device 106) associated with the same user, the cyberthreat detection platform 102 may cause the anomaly detection model to identify one of the connections as non-anomalous. For example, in a scenario where the cyberthreat detection platform 102 identified connections from both the first user device 104 and the second user device 106, the cyberthreat detection platform 102 may cause the anomaly detection model to perform a preliminary analysis of the user information of the first user device 104 and the second user device 106. Based on identifying that there are no anomalies in the user information of, for example, the second user device 106, the cyberthreat detection platform 102 may identify the second user device 106 as non-anomalous. In these examples, the cyberthreat detection platform 102 may allow the connection between the second user device 106 and the network 101 to proceed without modification, and might not perform any of the functions described below at steps 207-217 for the second user device 106.

At step 207, based on identifying an anomalous connection, the cyberthreat detection platform 102 may implement partitioning for the device associated with the anomalous connection. For example, based on identifying that the first user device 104 is associated with an anomalous connection, the cyberthreat detection platform 102 may implement one or more partitioning actions that place and/or otherwise cause the first user device 104 to be placed in a sandbox environment (e.g., a partition of network 101, a limited access version of network 101, and/or other sandbox environments). In some examples, the partitioning may limit the access first user device 104 has to network 101. For example, the partitioning may allow the first user device 104 to remain connected to the network 101 while preventing access to certain resources, devices, applications, and/or other components of the network 101. In some examples, the cyberthreat detection platform 102 may implement the partitioning such that the partitioning is not apparent to the user of the first user device 104. For example, the cyberthreat detection platform 102 may place the first user device 104 in a virtual recreation of the network 101 that appears identical to network 101 but changes and/or removes particular resources, applications, and/or other components of network 101 without notifying the user of first user device 104.

At step 208, the cyberthreat detection platform 102 may generate updated user information for the connection between the device associated with the anomalous connection (e.g., the first user device 104, and/or other devices). For example, the cyberthreat detection platform 102 may monitor online activity of the first user device 104 (e.g., while the first wireless data connection is established) during the connection between the first user device 104 and the network 101 and update the user information accordingly. For instance, based on identifying that the first user device 104 accessed one or more resources (e.g., web pages, files, applications, or the like) of the network 101 during the connection between the first user device 104 and the network 101, the cyberthreat detection platform 102 may update the user information associated with the connection between the first user device 104 and the network 101 to include the resources accessed by the user of the first user device 104. In these examples, the cyberthreat detection platform 102 may continuously and/or near-continuously update the user information (e.g., in preparation for generating cyberthreat scores for the connection, as described at step 209).

Referring to FIG. 2C, at step 209, the cyberthreat detection platform 102 may generate a cyberthreat score for the anomalous connection. For example, the cyberthreat detection platform 102 may generate a cyberthreat score for the anomalous connection based on the user information associated with the anomalous connection and the user profile corresponding to the user of the device (e.g., first user device 104, and/or other devices) associated with the anomalous connection, and using the anomaly detection model. The cyberthreat score may be an integer, decimal, fraction, percentage, binary value, alphabetical grade, and/or any other type of value. In some examples, in previously identifying the anomalous connection at step 207, the cyberthreat detection platform 102 may have input only a portion of the user information of, for example, the first user device 104. In these examples, the cyberthreat detection platform 102 may generate the cyberthreat score based on inputting all of the user information of the first user device 104 into the anomaly detection model.

In generating the cyberthreat score for the anomalous connection, the cyberthreat detection platform 102 may generate, using the anomaly detection model, a cyberthreat score indicating a likelihood of the anomalous connection being initiated by a cyberthreat actor (i.e., rather than by an authorized user associated with the device initiating the anomalous connection). For example, the cyberthreat detection platform 102 may cause the anomaly detection model to generate a cyberthreat score based on comparing the user information of the first user device 104 to the user profile (of the user profiles generated at step 201) associated with the user of the first user device 104 to identify a likelihood that the authorized user of the first user device 104 is the person initiating the anomalous connection. The cyberthreat score may therefore additionally or alternatively indicate a likelihood that the anomalous connection was initiated by an authorized user that is deviating from an expected/usual pattern of behavior (e.g., connecting from a new location, using a new device to initiate the connection, or the like). In generating the cyberthreat score the cyberthreat detection platform 102 may cause the anomaly detection model to identify, based comparing the user information to the user profile, shared characteristics between the user information and the user profile. For example, the cyberthreat detection platform 102 may cause the anomaly detection model to use the stored correlations used to train the anomaly detection model to identify relationships between portions of the user information and the user profile to identify which characteristics are shared. For instance, the anomaly detection model may identify, based on a stored correlation between the user profile and an identifier (e.g., a MAC address, an IP address, or the like) of the first user device 104, that the user information includes the same identifier, and may reduce the cyberthreat score for the anomalous connection based on the shared characteristic indicating a decreased likelihood that the anomalous connection is associated with a cyberthreat actor.

In some instances, the cyberthreat detection platform 102 may cause the anomaly detection model to generate the cyberthreat score based on the number of shared characteristics identified by comparing the user information of the anomalous connection to the user profile. For example, the cyberthreat detection platform 102 may cause the anomaly detection model to generate a cyberthreat score for an anomalous connection if the anomaly detection model identifies that, for example, three of five examined characteristics are shared, that might exceed, for example, a cyberthreat score for an anomalous connection for which the anomaly detection model identifies that four out of five examined characteristics are shared. Consider an example where the cyberthreat detection platform 102 causes the anomaly detection model to compare the user information to the user profile to identify whether, for instance, five characteristics (e.g., geographic location, web browser, MAC address, login time, and operating system) are shared (i.e., whether the characteristics match). In such an example, based on comparing the user information to the user profile, the anomaly detection model may identify that the geographic location of the first user device 104 and the expected geographic location indicated by the user profile are shared, that the web browser used by the first user device 104 and the expected web browser indicated by the user profile are shared, that the operating system of the first user device 104 and the expected operating system indicated by the user profile are shared, that the login time associated with the anomalous request and an expected range of login times indicated by the user profile are shared, but that the MAC address of the first user device 104 and the expected MAC address indicated by the user profile are not shared. The anomaly detection model may, based on the comparison, generate a cyberthreat score of, for example, 20%, because only one of out of five examined characteristics was not shared, indicating a low likelihood that the anomalous connection was initiated by a malicious actor. Alternatively, in the example where five characteristics are examined, the anomaly detection model may instead identify that only the geographic location of the first user device 104 and the expected geographic location indicated by the user profile are shared and may, as a result, generate a cyberthreat score of 80% because four out of five examined characteristics were not shared, indicating a high likelihood that the anomalous connection was initiated by a malicious actor.

It should be understood that the above merely represents an example of the method by which the cyberthreat score may be generated by comparing the user information of the anomalous connection and the user profile, and that the anomaly detection model may compare additional user information to additional information of/in the user profile in generating the cyberthreat score, may use different scoring arrangements, may use one or more weighting factors, or the like, without departing from the invention.

For example, the cyberthreat detection platform 102 may cause the anomaly detection model to generate the cyberthreat score by performing a comprehensive comparison between the user information of the anomalous connection and the user profile. In performing the comparison, the cyberthreat detection platform 102 may cause the anomaly detection model to assign different weights to different portions/pieces of information (i.e., different characteristics). For example, identifying that the geographic location of the first user device 104 does not match the expected geographic location indicated by the user profile may cause an increase of, e.g., 5% in the cyberthreat score while identifying that the MAC address associated with the first user device 104 does not match the expected MAC address indicated by the user profile may cause an increase of, e.g., 10% in the cyberthreat score, based on the MAC address characteristic being weighted twice as heavily as the geographic location characteristic. In some examples, the cyberthreat detection platform 102 may cause the anomaly detection model to generate an initial cyberthreat score and subsequently update the cyberthreat score by applying the one or more different weights.

In some examples, the anomaly detection model may use one or more machine learning algorithms in generating the cyberthreat score. For example, the cyberthreat detection platform 102 may have previously trained the anomaly detection model to employ a scoring algorithm to generate cyberthreat scores based on the number of shared characteristics between user information of anomalous connections and user profiles, and/or based on applying weighted values to the one or more shared characteristics. For instance, the anomaly detection model may execute the scoring algorithm using the following constraints/parameters:

$$If ( \frac{( number of characteristics not shared )}{( total number of compared characteristics )} ) \geq 0.5 , then : cyberthreat score = ( sum of weights for characteristics not shared - sum of weights for shared characteristics . If else , then : cyberthreat score = 0.$$

In this example, the anomaly detection model may execute the scoring algorithm to identify whether, based on comparing user information of the anomalous connection to the user profile, the quotient of the number of characteristics examined by the anomaly detection model and identified as not being shared between the user information and the user profile divided by the total number of characteristics that were examined meets or exceeds 50%. Based on identifying that the quotient meets or exceeds 50%, the anomaly detection model may generate a cyberthreat score equal to the difference between the sum of the weights for characteristics that were not shared and the sum of the weights for the shared characteristics. For instance, if the quotient exceeds 50% and the examined characteristics were the geographic location, web browser, MAC address, login time, and operating system, the anomaly detection engine may generate a cyberthreat score equivalent to the difference of the sum of the weights (e.g., 15%, 25%, and 40%, and/or any other weights) for each of the characteristics identified as not shared between the user information and the user profile (e.g., the operating system, the web browser, and the MAC address) and the sum of the weights (e.g., 5%, 15%, and/or any other weights) of the shared characteristics (e.g., the login time and the geographic information) resulting in, for this example, a cyberthreat score of 80%. Else, the anomaly detection model may generate a cyberthreat score of 0, indicating that the anomalous connection is not initiated by a cyberthreat actor. In other examples, the algorithm might not include the comparison of the quotient, and the cyberthreat detection platform 102 may simply cause the anomaly detection model to generate a cyberthreat score that is equivalent to the sum of the weights for the unshared characteristics. The weights may be identified based on training data used to train the anomaly detection model and/or user input.

It should be understood that the above example is merely one algorithm the anomaly detection model may be trained to employ in order to generate the cyberthreat score and in one or more instances additional or alternative algorithms may be employed and/or may correspond to different parameters. For example, in addition to the above algorithm, the cyberthreat detection platform 102 may cause the anomaly detection model to further update/refine the cyberthreat score based on weights applied to actions performed by the first user device 104 during the anomalous connection. The actions may be indicated by the updated user information of step 208. Certain actions (e.g., checking an account balance, transferring resources, or the like) may be weighted differently and may affect the cyberthreat score differently. For instance, based on updated user information identifying that the first user device 104 checked an account balance during the anomalous connection, the cyberthreat detection platform 102 may cause the anomaly detection model to increase the cyberthreat score by, for example, 5%, while based on updated user information identifying that the first user device 104 transferred resources out of an account the cyberthreat detection platform 102 may cause the anomaly detection model to increase the cyberthreat score by, for example, 10%, based on the action of transferring resources being weighted higher than the action of checking an account balance.

At step 210, the cyberthreat detection platform 102 may compare the cyberthreat score to a threshold score to identify whether the cyberthreat score satisfies the threshold score. The threshold score may be a value (e.g., an integer, decimal, fraction, percentage, binary value, alphabetical grade, and/or any other type of value) that, if satisfied, indicates the anomalous connection is or is likely to be a cyberthreat (e.g., the anomalous connection was initiated by a cyberthreat actor). The threshold score may be determined by manual user inputs setting the threshold score, by a ruleset stored in memory 112 of the cyberthreat detection platform 102, and/or by other methods. The threshold score may vary in one or more additional iterations of step 210 (e.g., for additional anomalous connections) based on configuration and/or rule changes. In identifying whether the cyberthreat score satisfies the threshold score, the cyberthreat detection platform 102 may identify whether the cyberthreat score meets or exceeds the threshold score. For example, the cyberthreat detection platform 102 may receive instructions configuring the cyberthreat detection platform 102 to identify anomalous connections with cyberthreat scores less than 75% as failing to satisfy the threshold score. Based on comparing the cyberthreat score to the threshold score, the cyberthreat detection platform 102 may identify whether the cyberthreat score satisfies the threshold score. In some instances, based on determining that the cyberthreat score is less than the threshold score, the cyberthreat detection platform 102 may identify that the cyberthreat score fails to satisfy the threshold score. For example, based on comparing a cyberthreat score of 20% to a threshold score of 75%, the cyberthreat detection platform 102 may identify that the cyberthreat score does not satisfy the threshold score. In other examples, based on determining that the cyberthreat score meets or exceeds the threshold score, the cyberthreat detection platform 102 may identify that the cyberthreat score satisfies the threshold score, indicating a likelihood that the anomalous connection is a cyberthreat. For instance, based on comparing a cyberthreat score of 80% to a threshold score of 75%, the cyberthreat detection platform 102 may identify that the cyberthreat score does satisfy the threshold score.

In some instances, based on identifying that the cyberthreat score does not satisfy the threshold score, the cyberthreat detection platform 102 may proceed to cease partitioning of the first user device 104 and flag the connection as non-anomalous. In these instances, the cyberthreat detection platform 102 may proceed to update the anomaly detection model, and may progress to step 217 without performing the functions described below at steps 211-216. In some examples, based on identifying that the cyberthreat score does satisfy the threshold score, the cyberthreat detection platform 102 may proceed to initiate one or more cyberthreat remediation actions at step 211.

At step 211, based on identifying that the cyberthreat score satisfies the threshold score, the cyberthreat detection platform 102 may initiate one or more cyberthreat remediation actions. For example, the cyberthreat detection platform 102 may execute programs, send instructions to devices, and/or otherwise cause the one or more cyberthreat remediation actions to be performed. In some examples, the cyberthreat detection platform 102 may initiate the one or more cyberthreat remediation actions automatically (i.e., without user input). In some instances, the cyberthreat detection platform 102 may initiate the one or more cyberthreat remediation actions after receiving user input from a user directing the cyberthreat detection platform 102 to initiate the one or more cyberthreat remediation actions (e.g., in response to the cyberthreat detection platform 102 causing display of a user interface, as described below at steps 212-213). It should be understood that the one or more cyberthreat remediation actions affect only the anomalous connection and that other connections (e.g., the connection between the second user device 106 and the network 101) might not be impacted by the cyberthreat remediation actions (i.e., the connections, such as a verified connection corresponding to the same user profile, may be maintained uninterrupted between the second user device 106 and the network 101). The one or more cyberthreat remediation actions may be and/or comprise actions such as causing a password reset for the user profile associated with the anomalous connection, disrupting the anomalous connection, sending a deterrent notification to the first user device 104 (e.g., via the communication interface 113 and while the first wireless data connection is established), redirecting the first user device 104 to an AI chatbot to ask additional security questions, and/or other actions designed to remedy the cyberthreat associated with the anomalous connection without disrupting other connections to the network 101. In this way, the cyberthreat detection platform 102 may resolve cyberthreats in a manner not apparent (i.e., unnoticed by, without disrupting the user experience, etc.) to other users of systems associated with network 101.

Additionally or alternatively, in some instances, the one or more cyberthreat remediation actions may be and/or comprise adding the first user device 104 to a watchlist of known cyberthreats. For example, the cyberthreat detection platform 102 may add the IP address and/or other identifiers of the first user device 104 to a list of known cyberthreats that may, in some instances, be used to update the anomaly detection model (e.g., at step 216 in FIG. 2D) to improve efficiency of detecting anomalous connections. Additionally or alternatively, in some examples, the one or more cyberthreat remediation actions may be and/or comprise incrementing a cyberthreat counter associated with the first user device 104. For example, the cyberthreat detection platform 102 may maintain a cyberthreat counter for the first user device 104 indicating the number of times the first user device 104 has been associated with an anomalous connection. In these examples, the one or more cyberthreat remediation actions may further comprise identifying, by comparing the cyberthreat counter to a threshold counter, whether the cyberthreat counter meets or exceeds the threshold counter. Based on identifying that the cyberthreat counter does meet or exceed the threshold counter, the cyberthreat detection platform 102 may output an indication that the first user device 104 is associated with a cyberthreat actor (e.g., a cyberthreat review interface, as described below at steps 212-213. Based on identifying that the cyberthreat counter does not meet or exceed the threshold counter, the cyberthreat detection platform 102 may increment the cyberthreat counter without taking further action. Additionally or alternatively, in some examples, the one or more cyberthreat remediation actions may be and/or comprise implementing additional authentication measures for the user profile corresponding to the anomalous connection. In these examples, the cyberthreat detection platform 102 may first compare the cyberthreat score to a second threshold score (e.g., as described below at steps 214-215).

At step 212, as part of and/or based on initiating the one or more cyberthreat remediation actions, the cyberthreat detection platform 102 may establish a connection with the administrator device 108. For example, the cyberthreat detection platform 102 may establish the connection with the administrator device 108 to cause display of a notification, such as a cyberthreat review notification and/or interface. In establishing the connection with the administrator device 108, the cyberthreat detection platform 102 may establish a third wireless data connection with the administrator device 108 to link the administrator device 108 with the cyberthreat detection platform 102 (e.g., in preparation for causing display of a user interface, and/or other functions). In some instances, the cyberthreat detection platform 102 may identify whether or not a connection is already established with the administrator device 108. If a connection is already established with the administrator device 108, the cyberthreat detection platform 102 might not re-establish the connection. If a connection is not yet established with the administrator device 108, the cyberthreat detection platform 102 may establish the third wireless data connection as described above.

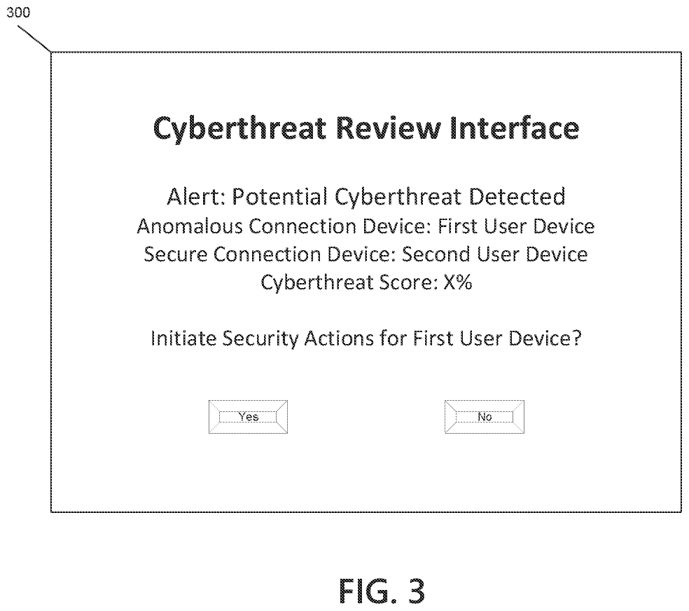

Referring to FIG. 2D, at step 213, the cyberthreat detection platform 102 may cause display of a user interface at the administrator device 108. For example, in causing display of the user interface, the cyberthreat detection platform 102 may transmit and cause display of a cyberthreat review interface for notifying a user (e.g., an administrator of the enterprise organization associated with the cyberthreat detection platform 102, and/or other users) of the cyberthreat associated with the anomalous connection, and/or for receiving manual confirmation to initiate the one or more cyberthreat remediation actions of step 211. In displaying the cyberthreat review interface, the cyberthreat detection platform 102 may cause display of a graphical user interface similar to cyberthreat review interface 300, which is illustrated in FIG. 3. For example, the cyberthreat detection platform 102 may output one or more instructions (via the communication interface 113 and while the third wireless data connection is established) to the administrator device 108, causing the administrator device 108 to display the cyberthreat review interface 300.

Referring to FIG. 3, in some instances, the cyberthreat review interface 300 may include information corresponding to the anomalous connection. For example, the cyberthreat review interface 300 may include information such as an alert that a potential cyberthreat was detected, an indication of the device (e.g., the first user device 104) associated with the anomalous connection, an indication of a second device (e.g., the second user device 106) corresponding to the same user profile but which is associated with a secure/verified connection, the cyberthreat score, and/or other information. The cyberthreat review interface 300 may also display interface elements or selectable options requesting user input. For example, the cyberthreat review interface 300 may display one or more of: an information entry field, a button or buttons, toggle or toggles, check box or boxes, and/or other interface elements. For example, as illustrated in FIG. 3, the interface elements may be one or more buttons the user might toggle to initiate a remediation action. In some instances, based on user input/feedback initiating a security action (e.g., based on manual review, by a supervisor and/or other individual, of the transmission), the cyberthreat detection platform 102 may receive the user input/feedback and initiate, based on the user input/feedback, the one or more cyberthreat remediation actions of step 212.

Referring again to FIG. 2D, at step 214, as part of and/or based on initiating the one or more cyberthreat remediation actions, the cyberthreat detection platform 102 may compare the cyberthreat score to a second threshold score (e.g., in order to identify whether additional authentication measures should be implemented for the user profile corresponding to the anomalous connection). In some examples, the second threshold score may exceed the threshold score of step 210. In comparing the cyberthreat score to the second threshold score, the cyberthreat detection platform 102 may identify whether cyberthreat score satisfies (e.g., meets or exceeds) the second threshold score. Based on identifying that the cyberthreat score does meet or exceed the second threshold score, the cyberthreat detection platform 102 may identify that additional authentication measures should be implemented and may proceed to step 215. Based on identifying that the cyberthreat score does not meet or exceed the second threshold score, the cyberthreat detection platform 102 may identify that additional authentication measures should not be implemented and may proceed to step 216 without performing the functions recited in step 215.

At step 215, based on identifying that the cyberthreat score satisfies the second threshold score, the cyberthreat detection platform 102 may implement (e.g., as part of the one or more cyberthreat remediation actions) additional authentication measures for the user profile corresponding to the anomalous request. The additional authentication measures may be and/or comprise one or more of: increasing a frequency of authentication requests, requiring two factor authentication, adding additional security questions, and/or other authentication measures. For example, the cyberthreat detection platform 102 may increase a frequency of authentication requests for the user profile. For instance, the cyberthreat detection platform 102 may increase the frequency with which a user is required to input their credentials to access the network 101 via the user profile from, for example, monthly to, for example, weekly, and/or any other periods of time.

At step 216, the cyberthreat detection platform 102 may update the user profile associated with the anomalous request. For example, the cyberthreat detection platform 102 may update the user profile based on the user information associated with the anomalous request and/or based on identifying whether the cyberthreat score satisfied the threshold score. In some examples, based on identifying that the cyberthreat score does not satisfy the threshold score (i.e., indicating that the anomalous connection is not associated with a cyberthreat) the cyberthreat detection platform 102 may update the user profile based on the user information associated with the anomalous connection so that future connections with the same user information will not be flagged as anomalous. For example, the cyberthreat detection platform 102 may update the user profile to include any information in the user information associated with the anomalous connection that is not in the user profile. In some instances, based on identifying that the cyberthreat score satisfied the threshold score, the cyberthreat detection platform 102 may update the user profile to include the first user device 104 in a list of anomalous devices. In doing so, the cyberthreat detection platform 102 may improve the efficiency of identifying anomalous connections by causing connections from the first user device 104 accessing the user profile to automatically be identified as anomalous connections.

Referring to FIG. 2E, at step 217, the cyberthreat detection platform 102 may refine, validate, and/or otherwise update the anomaly detection model. For example, the cyberthreat detection platform 102 may update the anomaly detection model based on initiating the one or more cyberthreat remediation actions and/or based on updating the user profile. In some instances, updating the anomaly detection model may include inputting the updated user profile and/or the results of the cyberthreat remediation actions into the anomaly detection model. By inputting the updated user profile and/or the results of the cyberthreat remediation actions into the anomaly detection model, the cyberthreat detection platform 102 may create an iterative feedback loop that may continuously and dynamically refine the anomaly detection model to improve its accuracy. For example, based on inputting the updated user profile and/or the results of the cyberthreat remediation actions into the anomaly detection model, the cyberthreat detection platform 102 may cause the anomaly detection model to store and/or update one or more correlations for future iterations of the feedback loop. For example, based on the user profile and/or the results of the cyberthreat remediation actions indicating that the first user device 104 is associated with a cyberthreat, the cyberthreat detection platform 102 may update the anomaly detection model to identify future connections between the first user device 104 and the network 101 as anomalous without further analysis being required.

In updating the anomaly detection model, the cyberthreat detection platform 102 may improve the accuracy of the model for identifying anomalous connections, which may, e.g., result in more efficient training of machine learning models trained by the cyberthreat detection platform 102 (and may in some instances, conserve computing and/or processing power/resources in doing so). The cyberthreat detection platform 102 may further increase the likelihood of detecting cyberthreats by improving the algorithms used to generate cyberthreat scores. For example, based on the user information of the anomalous connection, the cyberthreat detection platform 102 may adjust the weights for certain characteristics such that the anomaly detection model will increase the cyberthreat score for future connections associated with the user profile based on the adjusted weight.

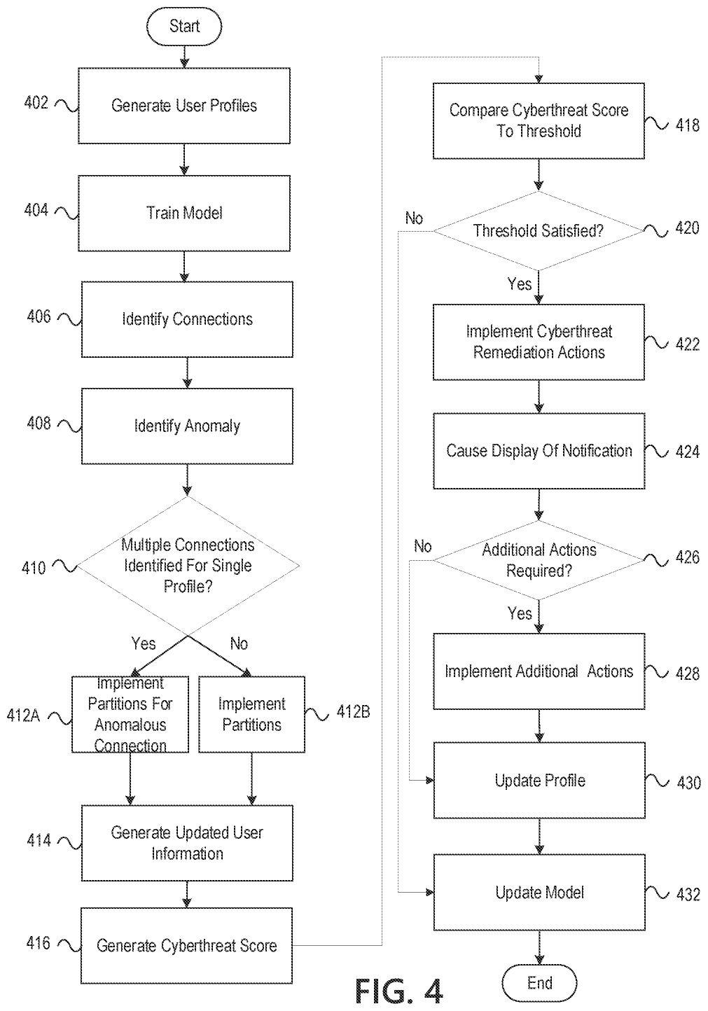

FIG. 4 depicts an illustrative method for cyberthreat penetration detection using a anomaly detection model in accordance with one or more example arrangements. Referring to FIG. 4, at step 402, a computing platform having at least one processor, a communication interface, and memory may generate user profiles. For example, the computing platform may generate user profiles for customers and/or employees of an enterprise organization. At step 404, the computing platform may train a machine learning model. For example, the computing platform may train a anomaly detection model to generate cyberthreat scores for anomalous connections. At step 406, the computing platform may identify connections between user devices and a network. At step 408, the computing platform may identify an anomaly. For example, the computing platform may identify an anomalous connection between a user device, using a user profile, and the network using the anomaly detection model. At step 410, the computing platform may identify whether there are multiple connections for a single user profile (e.g., the user profile of step 408). Based on identifying that there are multiple connections for a single profile, the computing platform may proceed to step 412A and implement partitions that affect only the anomalous connection. Based on identifying that there are not multiple connections for the single user profile, the computing platform may proceed to step 412B and implement partitions for the single connection for the user profile. At step 412A, based on identifying that there are multiple connections for the single user profile, the computing platform may implement partitions that affect only the anomalous connection while maintaining, uninterrupted, other connections using the same user profile. At step 412B, based on identifying that there are not multiple connections for the single user profile, the computing platform may implement partitions for the single identified connection.

At step 414, the computing platform may generate updated user information for the anomalous connection. At step 416, the computing platform may generate a cyberthreat score for the anomalous connection. For example, the computing platform may generate the cyberthreat score based on inputting user information into the anomaly detection model. At step 418, the computing platform may compare the cyberthreat score to a threshold score. At step 420, the computing platform may identify, based on comparing the cyberthreat score to the threshold score, whether the threshold score is satisfied. Based on identifying that the threshold score is not satisfied, the computing platform may proceed to step 432. Based on identifying that the threshold score is satisfied, the computing platform may proceed to step 422. At step 422, based on identifying that the threshold score is satisfied, the computing platform may implement one or more cyberthreat remediation actions. At step 424, based on or as part of the one or more cyberthreat remediation actions, the computing platform may cause display of a notification that the cyberthreat score satisfied the threshold score. At step 426, the computing platform may identify whether additional actions are required. For example, the computing platform may identify whether additional authentication measures should be implemented based on comparing the cyberthreat score to a second threshold score. Based on identifying that additional actions are not required, the computing platform may proceed to step 430. Based on identifying that additional actions are required, the computing platform may proceed to step 428. At step 428, based on identifying that additional actions are required, the computing platform may implement additional actions. For example, the computing platform may implement additional authentication actions for the user profile associated with the anomalous connection. At step 430, based on implementing the additional actions or based on identifying that additional actions were not required, the computing platform may update the user profile associated with the anomalous connection. At step 432, based on updating the profile or based on identifying that the cyberthreat score does not satisfy the threshold score, the computing platform may update the machine learning model. For example, the computing platform may update the anomaly detection model.

One or more aspects of the disclosure may be embodied in computer-usable data or computer-executable instructions, such as in one or more program modules, executed by one or more computers or other platforms to perform the operations described herein. Generally, program modules include routines, programs, objects, components, data structures, and the like that perform particular operations or implement particular abstract data types when executed by one or more processors in a computer or other data processing device. The computer-executable instructions may be stored as computer-readable instructions on a computer-readable medium such as a hard disk, optical disk, removable storage media, solid-state memory, RAM, and the like. The functionality of the program modules may be combined or distributed as desired in various arrangements. In addition, the functionality may be embodied in whole or in part in firmware or hardware equivalents, such as integrated circuits, application-specific integrated circuits (ASICs), field programmable gate arrays (FPGA), and the like. Particular data structures may be used to more effectively implement one or more aspects of the disclosure, and such data structures are contemplated to be within the scope of computer executable instructions and computer-usable data described herein.

Various aspects described herein may be embodied as a method, an apparatus, or as one or more computer-readable media storing computer-executable instructions. Accordingly, those aspects may take the form of an entirely hardware embodiment, an entirely software embodiment, an entirely firmware embodiment, or an embodiment combining software, hardware, and firmware aspects in any combination. In addition, various signals representing data or events as described herein may be transferred between a source and a destination in the form of light or electromagnetic waves traveling through signal-conducting media such as metal wires, optical fibers, or wireless transmission media (e.g., air or space). In general, the one or more computer-readable media may be and/or include one or more non-transitory computer-readable media.

As described herein, the various methods and acts may be operative across one or more computing servers and one or more networks. The functionality may be distributed in any manner, or may be located in a single computing device (e.g., a server, a client computer, and the like). For example, in alternative arrangements, one or more of the computing platforms discussed above may be combined into a single computing platform, and the various functions of each computing platform may be performed by the single computing platform. In such arrangements, any and/or all of the above-discussed communications between computing platforms may correspond to data being accessed, moved, modified, updated, and/or otherwise used by the single computing platform. Additionally or alternatively, one or more of the computing platforms discussed above may be implemented in one or more virtual machines that are provided by one or more physical computing devices. In such arrangements, the various functions of each computing platform may be performed by the one or more virtual machines, and any and/or all of the above-discussed communications between computing platforms may correspond to data being accessed, moved, modified, updated, and/or otherwise used by the one or more virtual machines.

Aspects of the disclosure have been described in terms of illustrative arrangements thereof. Numerous other arrangements, modifications, and variations within the scope and spirit of the appended claims will occur to persons of ordinary skill in the art from a review of this disclosure. For example, one or more of the steps depicted in the illustrative figures may be performed in other than the recited order, and one or more depicted steps may be optional in accordance with aspects of the disclosure.

What is claimed is:

1. A computing platform comprising:
at least one processor;
a communication interface communicatively coupled to the at least one processor; and
memory storing computer-readable instructions that, when executed by the at least one processor, configure the computing platform to:
generate, based on registration information of users, a plurality of user profiles, wherein a given user profile comprises user information for a corresponding user;
identify, based on monitoring a network, one or more user devices requesting a connection to the network;
train, based on the plurality of user profiles, an anomaly detection model, wherein training the anomaly detection model configures the anomaly detection model to identify anomalous connections and generate cyberthreat scores for connections based on input of user information;
identify, based on inputting user information associated with a user device, of the one or more user devices, into the anomaly detection model and based on a preliminary comparison of the user information to a user profile, of the plurality of user profiles and corresponding to a user of the user device, an anomalous connection associated with the user device;
initiate, based on identifying the anomalous connection, one or more partitioning actions for the user device;
generate, based on the user information and using the anomaly detection model, a cyberthreat score for the anomalous connection;
identify, by comparing the cyberthreat score to a threshold score, whether the cyberthreat score satisfies the threshold score, wherein the threshold score indicates the anomalous connection is a cyberthreat if the cyberthreat score satisfies the threshold score;
initiate, based on identifying that the cyberthreat score satisfies the threshold score, one or more cyberthreat remediation actions for the anomalous connection; and
update, based on initiating the one or more cyberthreat remediation actions, the anomaly detection model.

2. The computing platform of claim 1, wherein generating the cyberthreat score comprises, with the anomaly detection model:
comparing the user information associated with the user device to the user profile corresponding to the user;
identifying, based on the comparing, one or more shared characteristics between the user information and the user profile corresponding to the user; and
generating, based on the identifying the one or more shared characteristics, a cyberthreat score representing a likelihood of the anomalous connection being initiated by a cyberthreat actor.

3. The computing platform of claim 2, wherein the generating the cyberthreat score based on the identifying the one or more shared characteristics comprises:
generating, based on the one or more shared characteristics, an initial cyberthreat score;
applying, to the one or more shared characteristics, one or more weighting values; and
updating, based on the one or more weighting values, the initial cyberthreat score.

4. The computing platform of claim 1, wherein the instructions, when executed by the at least one processor, further configure the computing platform to:
update, based on identifying whether the cyberthreat score satisfies the threshold score and based on user information associated with the anomalous connection, the user profile corresponding to the user.

5. The computing platform of claim 1, wherein the one or more cyberthreat remediation actions comprise one or more of:
causing a password reset,
disrupting the anomalous connection,
adding the user device to a watchlist of known cyberthreats,
implementing additional authentication requirements for a user profile, of the plurality of user profiles, associated with the user device, or
causing output of a cyberthreat review notification.

6. The computing platform of claim 1, wherein the one or more cyberthreat remediation actions comprise:
incrementing a cyberthreat counter associated with the user device;
identifying, based on incrementing the cyberthreat counter and by comparing the cyberthreat counter to a threshold counter, whether the cyberthreat counter meets or exceeds the threshold counter; and
outputting, based on identifying that the cyberthreat counter meets or exceeds the threshold counter, an indication that the user device is associated with a cyberthreat actor.

7. The computing platform of claim 1, wherein the instructions, when executed by the at least one processor, further configure the computing platform to:
compare the cyberthreat score to a second threshold score, wherein the second threshold score exceeds the threshold score;
identify, based on the comparing, whether the cyberthreat score meets or exceeds the second threshold score; and
increase, based on identifying that the cyberthreat score meets or exceeds the second threshold score, a frequency of authentication requests based on a user profile, of the plurality of user profiles, associated with the user device.

8. The computing platform of claim 1, wherein initiating the one or more cyberthreat remediation actions comprises:
initiating, for the user device associated with the anomalous connection, the one or more cyberthreat remediation actions; and
maintaining, uninterrupted, a connection for a second user device, associated with a verified connection and with a user profile corresponding to the anomalous connection.

9. A method comprising:
at a computing device comprising at least one processor, a communication interface, and memory:
generating, based on registration information of users, a plurality of user profiles, wherein a given user profile comprises user information for a corresponding user;
identifying, based on monitoring a network, one or more user devices requesting a connection to the network;
training, based on the plurality of user profiles, an anomaly detection model, wherein training the anomaly detection model configures the anomaly detection model to identify anomalous connections and generate cyberthreat scores for connections based on input of user information;
identifying, based on inputting user information associated with a user device, of the one or more user devices, into the anomaly detection model and based on a preliminary comparison of the user information to a user profile, of the plurality of user profiles and corresponding to a user of the user device, an anomalous connection associated with the user device;
initiating, based on identifying the anomalous connection, one or more partitioning actions for the user device;
generating, based on the user information and using the anomaly detection model, a cyberthreat score for the anomalous connection;
identifying, by comparing the cyberthreat score to a threshold score, whether the cyberthreat score satisfies the threshold score, wherein the threshold score indicates the anomalous connection is a cyberthreat if the cyberthreat score satisfies the threshold score;
initiating, based on identifying that the cyberthreat score satisfies the threshold score, one or more cyberthreat remediation actions for the anomalous connection; and
updating, based on initiating the one or more cyberthreat remediation actions, the anomaly detection model.

10. The method of claim 9, wherein generating the cyberthreat score comprises, with the anomaly detection model:
comparing the user information associated with the user device to the user profile corresponding to the user;
identifying, based on the comparing, one or more shared characteristics between the user information and the user profile corresponding to the user; and
generating, based on the identifying the one or more shared characteristics, a cyberthreat score representing a likelihood of the anomalous connection being initiated by a cyberthreat actor.

11. The method of claim 10, wherein the generating the cyberthreat score based on the identifying the one or more shared characteristics comprises:
generating, based on the one or more shared characteristics, an initial cyberthreat score;
applying, to the one or more shared characteristics, one or more weighting values; and
updating, based on the one or more weighting values, the initial cyberthreat score.

12. The method of claim 9, wherein the one or more cyberthreat remediation actions comprise one or more of:
causing a password reset,
disrupting the anomalous connection,
adding the user device to a watchlist of known cyberthreats,
implementing additional authentication requirements for a user profile, of the plurality of user profiles, associated with the user device, or
causing output of a cyberthreat review notification.

13. The method of claim 9, wherein the one or more cyberthreat remediation actions comprise:
incrementing a cyberthreat counter associated with the user device;
identifying, based on incrementing the cyberthreat counter and by comparing the cyberthreat counter to a threshold counter, whether the cyberthreat counter meets or exceeds the threshold counter; and
outputting, based on identifying that the cyberthreat counter meets or exceeds the threshold counter, an indication that the user device is associated with a cyberthreat actor.

14. The method of claim 9, further comprising:
comparing the cyberthreat score to a second threshold score, wherein the second threshold score exceeds the threshold score;
identifying, based on the comparing, whether the cyberthreat score meets or exceeds the second threshold score; and
increasing, based on identifying that the cyberthreat score meets or exceeds the second threshold score, a frequency of authentication requests based on a user profile, of the plurality of user profiles, associated with the user device.

15. One or more non-transitory computer-readable media storing instructions that, when executed by a computing platform comprising at least one processor, a communication interface, and memory, cause the computing platform to:
generate, based on registration information of users, a plurality of user profiles, wherein a given user profile comprises user information for a corresponding user;
identify, based on monitoring a network, one or more user devices requesting a connection to the network;
train, based on the plurality of user profiles, an anomaly detection model, wherein training the anomaly detection model configures the anomaly detection model to identify anomalous connections and generate cyberthreat scores for connections based on input of user information;
identify, based on inputting user information associated with a user device, of the one or more user devices, into the anomaly detection model and based on a preliminary comparison of the user information to a user profile, of the plurality of user profiles and corresponding to a user of the user device, an anomalous connection associated with the user device;
initiate, based on identifying the anomalous connection, one or more partitioning actions for the user device;
generate, based on the user information and using the anomaly detection model, a cyberthreat score for the anomalous connection;
identify, by comparing the cyberthreat score to a threshold score, whether the cyberthreat score satisfies the threshold score, wherein the threshold score indicates the anomalous connection is a cyberthreat if the cyberthreat score satisfies the threshold score;
initiate, based on identifying that the cyberthreat score satisfies the threshold score, one or more cyberthreat remediation actions for the anomalous connection; and
update, based on initiating the one or more cyberthreat remediation actions, the anomaly detection model.

16. The one or more non-transitory computer-readable media of claim 15, wherein generating the cyberthreat score comprises, with the anomaly detection model:
comparing the user information associated with the user device to the user profile corresponding to the user;
identifying, based on the comparing, one or more shared characteristics between the user information and the user profile corresponding to the user; and
generating, based on the identifying the one or more shared characteristics, a cyberthreat score representing a likelihood of the anomalous connection being initiated by a cyberthreat actor.

17. The one or more non-transitory computer-readable media of claim 16, wherein the generating the cyberthreat score based on the identifying the one or more shared characteristics comprises:
generating, based on the one or more shared characteristics, an initial cyberthreat score;
applying, to the one or more shared characteristics, one or more weighting values; and
updating, based on the one or more weighting values, the initial cyberthreat score.

18. The one or more non-transitory computer-readable media of claim 15, wherein the one or more cyberthreat remediation actions comprise one or more of:
causing a password reset,
disrupting the anomalous connection,
adding the user device to a watchlist of known cyberthreats,
implementing additional authentication requirements for a user profile, of the plurality of user profiles, associated with the user device, or
causing output of a cyberthreat review notification.

19. The one or more non-transitory computer-readable media of claim 15, wherein the one or more cyberthreat remediation actions comprise:
incrementing a cyberthreat counter associated with the user device;
identifying, based on incrementing the cyberthreat counter and by comparing the cyberthreat counter to a threshold counter, whether the cyberthreat counter meets or exceeds the threshold counter; and
outputting, based on identifying that the cyberthreat counter meets or exceeds the threshold counter, an indication that the user device is associated with a cyberthreat actor.

20. The one or more non-transitory computer-readable media of claim 15, storing instructions that, when executed, further cause the computing platform to:
compare the cyberthreat score to a second threshold score, wherein the second threshold score exceeds the threshold score;
identify, based on the comparing, whether the cyberthreat score meets or exceeds the second threshold score; and
increase, based on identifying that the cyberthreat score meets or exceeds the second threshold score, a frequency of authentication requests based on a user profile, of the plurality of user profiles, associated with the user device.
